(19) United States
(12) Patent Application Publication
(10) Pub. No.: US 2026/0346923 A1
(43) Pub. Date: Nov. 5, 2026

(54) LOCKING HINGE

(71) Applicant: Atieva, Inc., Newark, CA (US)

(72) Inventors: Daniel Teyrovsky Livingston, Hayward, CA (US); Zeb Michael Coughenour, Redwood City, CA (US); Jared Nussey, San Leandro, CA (US)

(21) Appl. No.: 19/198,584

(22) Filed: May 5, 2025

(51) Int. Cl. B62D 25/20; B60N 2/36

(52) U.S. Cl. CPC B62D 25/20; B60N 2/36; B60N 2002/363

(57) ABSTRACT

A locking hinge comprises: a first flange including a first knuckle with a first bore and a first leaf, the first knuckle having a slot at the second end and being longer along the rotation axis than the first leaf; a hinge pin having a shoulder at the first end, extending through the first bore, having a perpendicular key at the second end; a second flange including a second knuckle and a second leaf, the second knuckle having a second bore through which the first knuckle and the hinge pin extend, and a first slot at the second end; and a biasing member to bias the hinge pin so the key extends through the slot and the first slot, wherein translation of the hinge pin causes the key to extend through the slot and not through the first slot so that the second flange can rotate.

### TECHNICAL FIELD

This document relates to a locking hinge.

### BACKGROUND

Attempts have been made to create locking hinges for various applications. However, these prior approaches have either been subject to being overpowered so that the hinge becomes unlocked, or their actuation mechanisms have been awkward to operate, or they offer a pinch hazard, or their folding braces occupy the very space needed for folding closed, rendering the hinges suboptimal.

### SUMMARY

In a first aspect, a locking hinge comprises: a first flange defining a rotation axis of the locking hinge, the first flange including a first knuckle and a first leaf, the first knuckle having a first end and a second end opposite the first end, the first knuckle having a first bore, the first knuckle having a slot at the second end, wherein a length of the first knuckle along the rotation axis is greater than a length of the first leaf along the rotation axis; a hinge pin having a first end and a second end opposite the first end, the hinge pin having a shoulder at the first end, the hinge pin extending through the first bore of the first flange, the hinge pin having a key that extends perpendicularly to the rotation axis at the second end; a second flange including a second knuckle and a second leaf, the second knuckle having a first end and a second end opposite the first end, the second knuckle having a second bore through which the first knuckle and the hinge pin extend, the second knuckle having a first slot at the second end; and a biasing member positioned between the shoulder of the hinge pin and the first end of the first knuckle to provide a bias on the hinge pin toward a first position where the key extends through the slot of the first knuckle and through the first slot of the second knuckle so that the second flange is locked from rotating relative to the first flange, wherein translation of the hinge pin along the rotation axis against the bias of the biasing member places the hinge pin in a second position where the key extends through the slot of the first knuckle and does not extend through the first slot of the second knuckle so that the second flange is free to rotate relative to the first flange.

Implementations can include any or all of the following features. The key of the hinge pin comprises two keys extending in opposite directions from the key, wherein the slot of the first knuckle comprises two slots formed opposite each other on the first knuckle, and wherein the first slot of the second knuckle comprises two first slots formed opposite each other on the second knuckle. The locking hinge further comprises a cap attached to the first end of the first knuckle, the cap covering the first end of the first knuckle, the shoulder of the hinge pin, and the biasing member. The shoulder is formed by a sleeve attached to the first end of the hinge pin. The locking hinge further comprises an opening in the cap for actuating the hinge pin to translate along the rotation axis. The locking hinge further comprises a button attached to the first end of the hinge pin, the button extending out of the cap through the opening. An opening of the first slot is wider than a remainder of the first slot. The opening of the first slot has a rounded portion. In the first position of the hinge pin the first flange extends in substantially a same direction as the second flange. In the first position of the hinge pin the first flange forms a nonzero angle with the second flange. The second knuckle has also a second slot at the second end, and wherein the hinge pin has also a third position where the key extends through the slot of the first knuckle and through the second slot of the second knuckle so that the second flange is locked from rotating relative to the first flange and forms a different angle with the first flange than in the first position. An opening of the second slot is wider than a remainder of the second slot. The opening of the second slot has a rounded portion. The locking hinge further comprises a rib on the first leaf of the first flange. The locking hinge further comprises a rib on the second leaf of the second flange.

In a second aspect, a load floor for a footwell of a vehicle comprises: a load floor panel configured to fit across the footwell of the vehicle; a leg panel; and a first locking hinge attached to the load floor panel and the leg panel, the first locking hinge comprising: a first flange defining a rotation axis of the first locking hinge, the first flange including a first knuckle and a first leaf, the first knuckle having a first end and a second end opposite the first end, the first knuckle having a first bore, the first knuckle having a first slot at the second end, wherein a length of the first knuckle along the rotation axis is greater than a length of the first leaf along the rotation axis; a hinge pin having a first end and a second end opposite the first end, the hinge pin having a shoulder at the first end, the hinge pin extending through the first bore of the first flange, the hinge pin having a key that extends perpendicularly to the rotation axis at the second end; a second flange including a second knuckle and a second leaf, the second knuckle having a first end and a second end opposite the first end, the second knuckle having a second bore through which the first knuckle and the hinge pin extend, the second knuckle having a second slot at the second end; and a biasing member positioned between the shoulder of the hinge pin and the first end of the first knuckle to provide a bias on the hinge pin toward a first position where the key extends through the first slot of the first knuckle and through the second slot of the second knuckle so that the second flange is locked from rotating relative to the first flange, wherein the hinge pin being in the first position corresponds to the leg panel extending between the load floor panel and a bottom of the footwell of the vehicle and supporting the load floor panel, wherein translation of the hinge pin along the rotation axis against the bias of the biasing member places the hinge pin in a second position where the key extends through the first slot of the first knuckle and does not extend through the second slot of the second knuckle so that the second flange is free to rotate relative to the first flange.

Implementations can include any or all of the following features. The load floor further comprises a second locking hinge attached to the load floor panel and the leg panel. The first locking hinge has a first button for unlocking the first locking hinge, the first locking hinge positioned so that the first button is located at a first side edge of the load floor, and wherein the second locking hinge has a second button for unlocking the second locking hinge, the second locking hinge positioned so that the second button is located at a second side edge of the load floor opposite to the first side edge. The hinge pin has also a third position where the key extends through the first slot of the first knuckle and through a third slot of the second knuckle so that the second flange is locked from rotating relative to the first flange and forms a different angle with first flange than in the first position. In the third position of the hinge pin the load floor panel extends in substantially a same direction as the leg panel.

### BRIEF DESCRIPTION OF DRAWINGS

FIG. 1A shows an example of a locking hinge with a hinge pin in a first locked position.

FIG. 1B indicates a slot angle of the locking hinge of FIG. 1A in the first locked position.

FIG. 1C shows the flanges separate from a remainder of the locking hinge of FIG. 1A.

FIG. 2 shows an example of the locking hinge of FIG. 1A with the hinge pin in a second unlocked position.

FIG. 3 shows a cross section of the locking hinge of FIG. 2.

FIG. 4A shows the locking hinge of FIG. 1A with the hinge pin in a third locked position with a view of the key and keyway slots.

FIG. 4B indicates a slot angle of the locking hinge in FIG. 4A of the third locked position.

FIG. 5 shows an example of a load floor having locking hinges, the load floor being in an open locked position.

FIG. 6 shows an example side view of the load floor of FIG. 5, the load floor being in an closed locked position.

FIG. 7 shows an example of a vehicle with a footwell covered by a load floor.

FIG. 8 shows an example section view of the vehicle of FIG. 7 with the seat recliner in an upright position.

FIG. 9 shows an example section view of the vehicle of FIG. 7 with the seat recliner in a folded position.

Like reference symbols in the various drawings indicate like elements.

### DETAILED DESCRIPTION

This document describes examples of systems and techniques for providing or using a locking hinge for discrete position control. In some implementations, one or more locking hinges can be used on an interior accessory of a vehicle. For example, a locking hinge can be used to control position of two panels relative to each other (e.g., a closed position for storage inside or outside the vehicle, or an open position to support itself in an in-car position. A locking hinge according to the present subject matter can provide at least the advantages of controlling the angle of the locked position (e.g., to avoid that the hinge is inadvertently locked in a wrong or suboptimal position), and preventing that the locking is overcome by the application of the amounts of torque that may be encountered during normal use.

A locking hinge can be used to control position of two components. When the components are panels, the locking hinge can place the panels in either a closed or an open position. In the closed position the panels can assume a position resembling the covers of a closed book, for example so that the panels can be stored in the vehicle (e.g., in a sub-trunk compartment thereof). In the open position (e.g., in a locked position at some angle relative to each other), the panels can conveniently be dropped into a footwell of a row of vehicle seats (e.g., a third row), to create a continuous load floor between the trunk and forward seats (e.g., a second row of seats). Such a continuous load floor can be useful for cargo support whether the forward seats have been folded or are deployed. The locking hinge can obviate a need for a separate latch to hold the panels closed for storage, thereby consolidating parts of a load floor assembly. The locking hinge can provide static structural support for the load floor (which can be referred to as a gap hider), so that when the forward seats are folded down, the horizontal panel stays secured when suitcases or other cargo are slid across. The locking hinge can transfer a force path from a top load floor panel into a lower bulkhead panel which is wedged between the car's floor and the back of the forward second row seat frame. The locking hinge can control the panels'positions so that a customer would reliably deploy the panels completely at the correct angle each time. By contrast, without the locking hinge of the present subject matter, existing options like a friction hinge, detent hinge, or spring hinge might be used, which would not ensure that the customer would perform the action completely and get the product to work as intended. With the locking hinge controlling the angles the panels are deployed, correct functional performance can be ensured without requiring close technical attention by the customer. The locking hinge also holds the load floor in place, preventing displacement of the load floor when moving cargo around the trunk area. The locking hinge allows the gap hider accessory product to be a true drop-in accessory, without modifications to the vehicle interior. Placing the button(s) by which to activate the hinge at a side edge of the load floor can ensure that the customer's fingers are outside of the mechanism or possible pinch points of the panels.

As used herein, a vehicle is a machine that transports passengers or cargo, or both. A vehicle can have one or more motors. Examples of vehicles include, but are not limited to, cars, trucks, and buses. The vehicle can include a passenger compartment accommodating one or more persons.

As used herein, a knuckle of a flange of a hinge is any portion of the flange capable of guiding the rotation of the flange about a rotation axis of the hinge. In some implementations, the knuckle can include a collar, such as a substantially cylindrical member having a central bore for the hinge pin.

Examples described herein refer to a top, bottom, front, or rear. These and similar expressions identify things or aspects in a relative way based on an express or arbitrary notion of perspective. That is, these terms are illustrative only, used for purposes of explanation, and do not necessarily indicate the only possible position, direction, and so on.

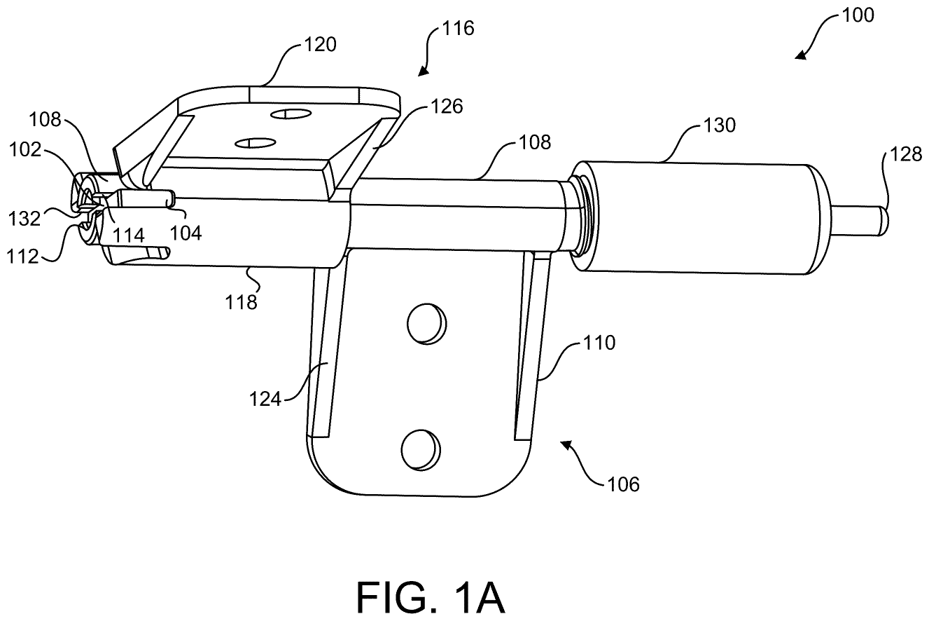

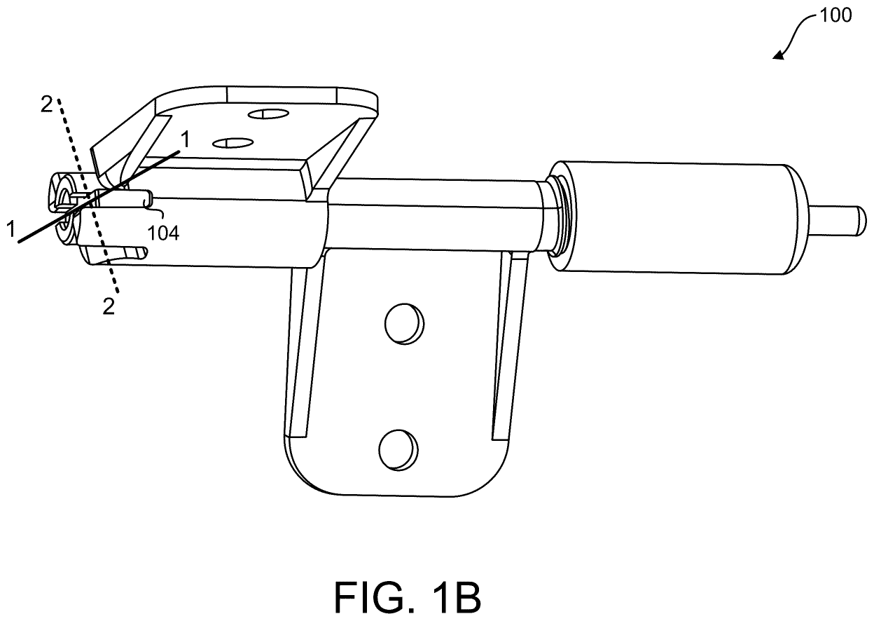

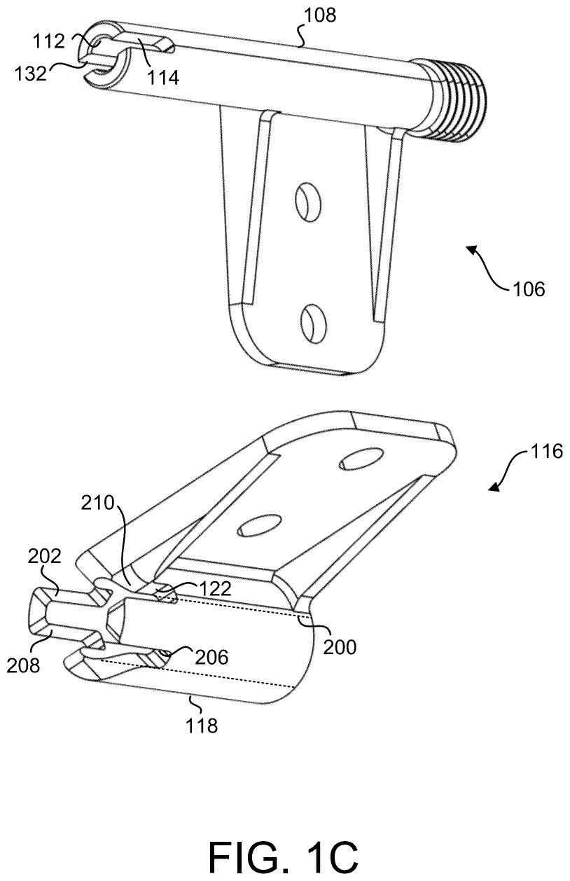

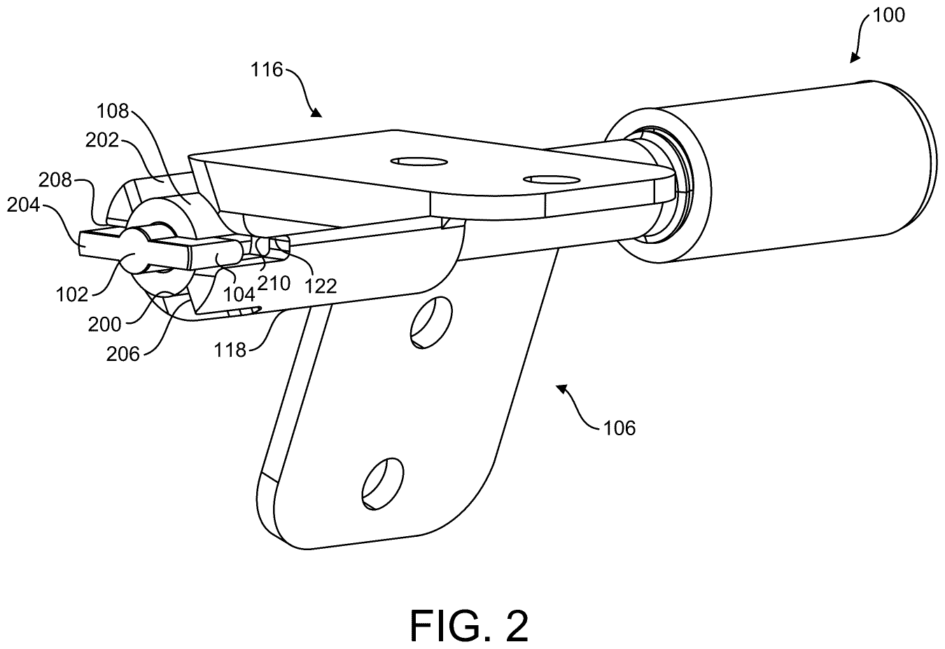

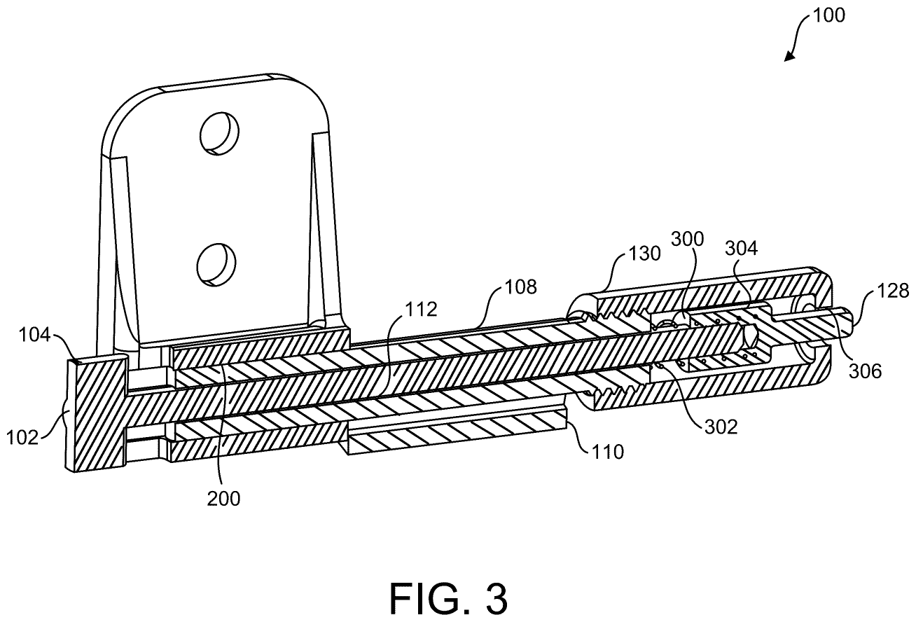

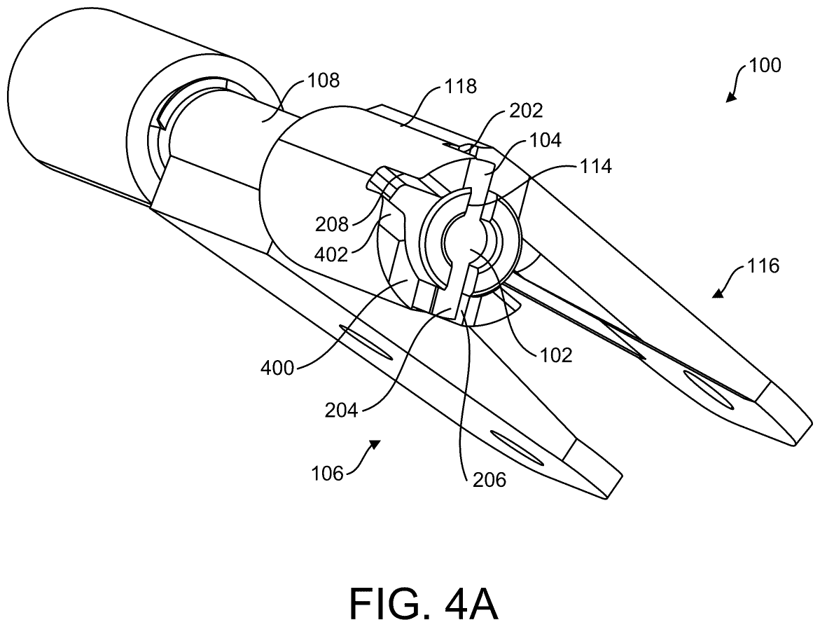

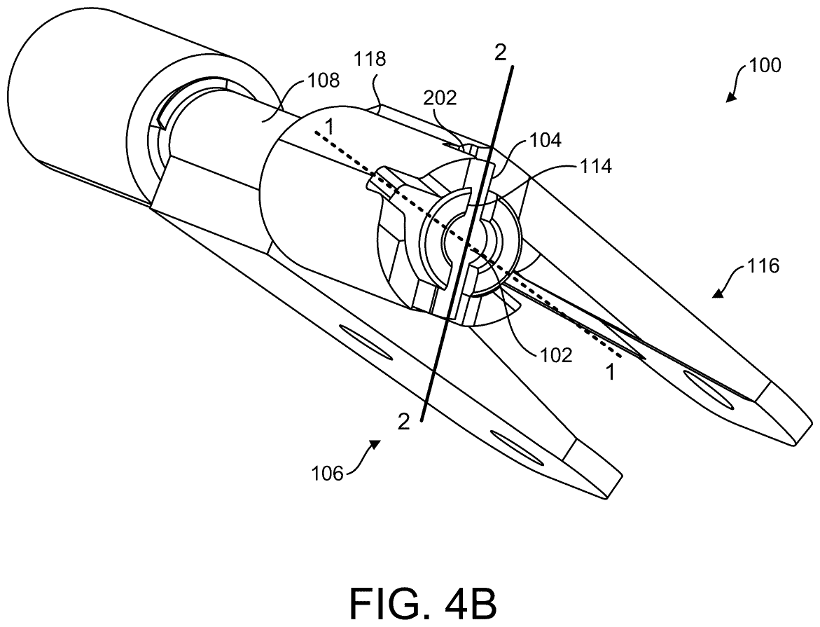

FIGS. 1A-1C show an example of a locking hinge 100 with a hinge pin 102 in a first locked position. FIG. 2 shows an example of the locking hinge 100 of FIG. 1A with the hinge pin 102 translated along its axis, outside of the keyway slots, in a second unlocked position. FIG. 3 shows a cross section of the locking hinge 100 of FIG. 2. FIGS. 4A-4B show the locking hinge 100 of FIG. 1A with the hinge pin in a third locked position with the flange 116 (i.e., the outer hinge flange) rotated closed. The locking hinge 100 can be used with one or more other examples described elsewhere herein.

The hinge pin 102 is at the center of a rotation axis for the locking hinge 100. The hinge pin 102 has a first end (toward the right in the illustration) and a second end (toward the left in the illustration) opposite the first end. The hinge pin 102 has a shoulder 300 at the first end. For example, the shoulder 300 can be threaded onto the first end of the hinge pin 102. The hinge pin 102 has a key 104 that extends perpendicularly to the rotation axis at the second end.

The locking hinge 100 includes a flange 106 that defines the rotation axis of the locking hinge 100. The flange 106 includes a knuckle 108 (e.g., an inner hinge cylinder) and a leaf 110. The knuckle 108 has a first end (toward the right in the illustration) and a second end (toward the left in the illustration) opposite the first end. The knuckle 108 has a bore 112 through which the hinge pin 102 extends. The knuckle 108 has a slot 114 at the second end. A length of the knuckle 108 along the rotation axis is greater than a length of the leaf 110 along the rotation axis.

The locking hinge 100 includes a flange 116 including a knuckle 118 (e.g., an outer hinge cylinder) and a leaf 120. The knuckle 118 has a first end (toward the right in the illustration) and a second end (toward the left in the illustration) opposite the first end. The knuckle 118 has a bore 200 through which the knuckle 108 and the hinge pin 102 (inside the bore 112 of the knuckle 108) extend. The knuckle 118 has at least a slot 122 at the second end. In FIG. 1A, the locking hinge 100 is shown in a first locked position where the key 104 of the hinge pin 102 extends through the slot 114 and through the slot 122 so that the flange 116 is locked from rotating relative to the flange 106. In some implementations, the first locked position corresponds to the flange 106 forming a nonzero angle with the flange 116. FIG. 1B indicates a slot angle 1 of the locking hinge 100 of FIG. 1A in the first locked position. That is, in the first locked position the key 104 is oriented at the slot angle 1 and is not currently oriented at a slot angle 2, which is also indicated for clarity. The leaf 110 can have one or more ribs 124 to strengthen the flange 106. Also or instead, the leaf 120 can have one or more ribs 126 to strengthen the flange 116.

The locking hinge 100 includes a biasing member 302 positioned between (e.g., compressed by) the shoulder 300 of the hinge pin 102 and the first end of the knuckle 108. The biasing member 302 provides a bias on the hinge pin 102 toward the position shown in FIG. 1A. The illustration shows the biasing member 302 in a fully extended position for clarity. In some implementations, the biasing member 302 can include a compression spring.

The locking hinge 100 includes a button 128 attached (in this case threaded) to the first end of the hinge pin 102. For example, the shoulder 300 can be part of the structure that forms the button 128. The button 128 can be pressed to translate the hinge pin 102 along the rotation axis. Pressing this button releases the key pin beyond the key slots, allowing a user to rotate the hinges relative to each other.

FIG. 2 shows that translation of the hinge pin 102 has occurred along the rotation axis against the bias of the biasing member 302 and that the hinge pin 102 is currently in a second unlocked position where the key 104 extends through the slot 114 of the knuckle 108 and does not extend through the slot 122 of the knuckle 118 so that the flange 116 is free to rotate relative to the flange 106 in at least one rotational direction.

The locking hinge 100 includes a cap 130 attached to the first end of the knuckle 108. The cap 130 covers the first end of the knuckle 108, the shoulder 300 of the hinge pin 102, and the biasing member 302. In some implementations, the shoulder 300 is formed by a sleeve 304 attached to (e.g., threaded onto) the first end of the hinge pin 102. For example, the sleeve 304 can have a substantially cylindrical shape with a blind opening for the first end of the hinge pin 102. The locking hinge 100 can include an opening 306 in the cap 130 for actuating the hinge pin 102 to translate along the rotation axis. The button 128 can extend out of the cap 130 through the opening 306. In some implementations, assembly can be performed by inserting the hinge pin 102 through the bore 112 of the flange 106 in a direction from left to right in the illustration, thereafter installing the biasing member 302 onto the first end of the hinge pin 102, thereafter mounting (e.g., threading) the sleeve 304 to the first end of the hinge pin 102 to prevent the hinge pin 102 from sliding out of the bore 112 of the flange 106, and then mounting (e.g., threading) the cap 130 to the knuckle 108. Accordingly, in the second unlocked position of the hinge pin 102 relative rotation can occur between the flange 116 and the flange 106 (e.g., by a user manually applying torque directly or indirectly between the flange 116 and the flange 106).

The locking hinge 100 can include a slot 202 at the second end of the knuckle 118. For example, relative rotation between the flange 116 and the flange 106 in the second unlocked position of the hinge pin 102 can cause the key 104 to enter and extend through the slot 202. FIG. 4A shows, with a view of the key and keyway slots, that this rotation has caused the hinge pin 102 to assume a third locked position. FIG. 4B indicates the slot angle 2 of the locking hinge of FIG. 4A in the third locked position, where the key 104 extends through the slot 114 of the knuckle 108 and through the slot 202 of the knuckle 118 so that the flange 116 is locked from rotating relative to the flange 106 and forms a different angle with the flange 106 than in the first locked position. For example, in the third locked position the flange 116 can extend in substantially a same direction as the flange 106 (e.g., as shown).

The locking hinge 100 can include two or more keys on the hinge pin 102. Here, the locking hinge 100 includes also a key 204 that extends perpendicularly to the rotation axis at the second end of the hinge pin 102. The key 204 and the key 104 extend in opposite directions from the hinge pin 102. The knuckle 108 here also includes a slot 132, wherein the slot 132 and the slot 114 are formed opposite each other on the knuckle 108. The knuckle 118 here also includes a slot 206, wherein the slot 206 and the slot 202 are formed opposite each other on the knuckle 118. The knuckle 118 here also includes a slot 208, wherein the slot 208 and the slot 122 are formed opposite each other on the knuckle 118.

Any slot of the locking hinge 100 can have an opening that is wider than a remainder of the slot. In some implementations, the knuckle 118 has a rounded opening 210 in the slot 122. The rounded opening 210 can facilitate the transition where the key 104 enters the slot 122. In some implementations, the knuckle 118 has a rounded opening 400 in the slot 206. The rounded opening 400 can facilitate the transition where the key 204 enters the slot 206. In some implementations, the knuckle 118 has a rounded opening 402 in the slot 208. The rounded opening 402 can facilitate the transition where the key 204 enters the slot 208. Having one or more slots with a rounded opening can allow the slots to act like ramps and make the user experience in adjusting the locking hinge 100 more smooth and intuitive, helping the key pin slide into locking position

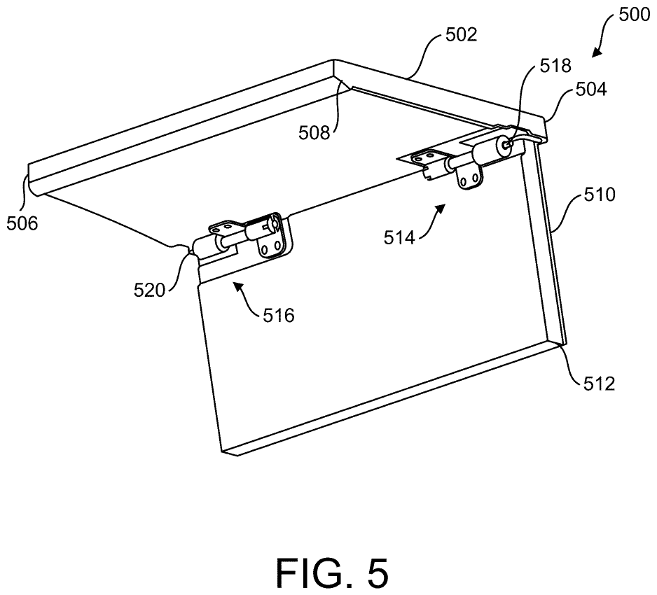

FIG. 5 shows an example of a load floor 500 having locking hinges, the load floor being in an open locked position. This example shows the locking hinges in a use-case scenario, an automotive cargo load floor with two panels. The load floor 500 is an example of a load floor that can be used to at least partially cover a footwell of a vehicle. The load floor 500 can be used with one or more other examples described elsewhere herein.

The load floor 500 includes a load floor panel 502 that is configured to fit across the footwell of the vehicle. In some implementations, the load floor panel 502 has a front end 504 configured to abut a seatback of a seat mounted forward of the footwell, and a rear end 506 configured to abut another vehicle structure, in this case the main trunk floor. For example, the front end 504 can have a substantially flat surface facing the forward seat, and the rear end 506 can have a chamfer 508 to engage with the motor bay structure between rear wheels of the vehicle that forms the trunk floor. In this way, when the vehicle's third ow seats are stored, the load floor can be installed over the third row footwell to form a continuous cargo floor for supporting payloads. When the second row seats are folded flat, the load floor can be installed to convert the trunk, second and third row passenger seats into a continuous cargo area.

The load floor 500 includes a leg panel 510. The leg panel 510 has an end 512 configured to rest against the cabin floor at the bottom of the footwell to support the load floor panel 502.

The load floor 500 has a locking hinge 514, which is a first instance of the locking hinge 100 of FIG. 1A, and a locking hinge 516, which is a second instance of the locking hinge 100. The locking hinge 514 can have the flange 106 of FIG. 1A attached to the leg panel 510, and can have the flange 116 of FIG. 1A attached to the load floor panel 502. Similarly, the locking hinge 516 can have the flange 116 of FIG. 1A attached to the leg panel 510, and can have the flange 106 of FIG. 1A attached to the load floor panel 502. Alternatively, the flanges 106 and 116 can be attached to the respective opposite panels. In this way, a single hinge design can be used for symmetrically opposite button operation.

The locking hinge 514 and the locking hinge 516 are here positioned toward the respective side edges of the load floor panel 502 and the leg panel 510. A button 518 of the locking hinge 514, and a button 520 of the locking hinge 516, are then located conveniently for being actuated by a user. For example, when the user is simultaneously pressing the button 518 and the button 520, the user's hands are positioned outside of a possible pinch area (if one exists) between the front end 504 and the leg panel 510. In this application, operating both buttons to unlock the hinges acts as a preventative safety measure.

That is, in the open locked position as illustrated, the load floor 500 can be positioned to cover a footwell of a vehicle, with the leg panel 510 supporting the load floor panel 502 against the load that may be placed on the load floor 500.

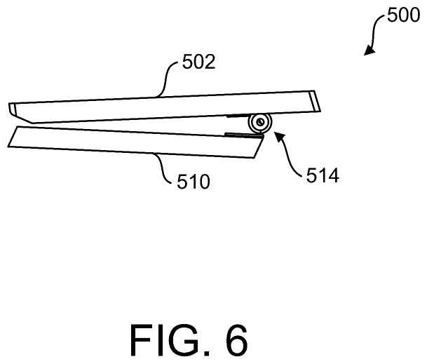

FIG. 6 shows an example side view of the load floor 500 of FIG. 5, the load floor 500 being in a closed locked position. In the closed locked position of the load floor 500 the load floor panel 502 extends in substantially a same direction as the leg panel 510. For example, this orientation can correspond to the third locked position shown in FIG. 4A. In some implementations, the closed locked position of the load floor 500 can be used when the load floor 500 is being stored (e.g., not being used). For example, the load floor 500 can be stored within the vehicle (e.g., in a sub-trunk) or outside of the vehicle.

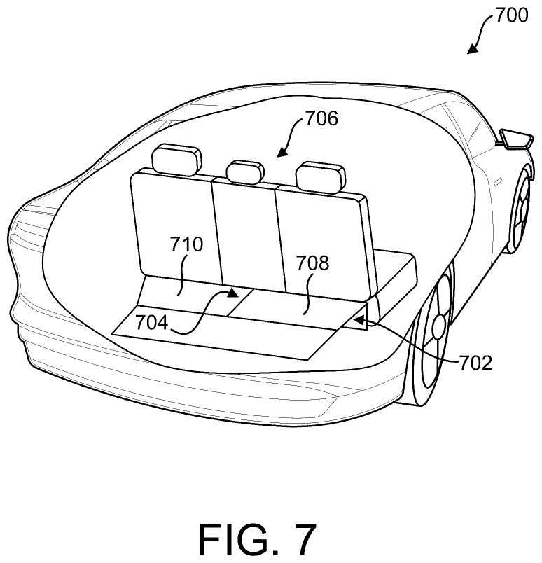

FIG. 7 shows an example of a vehicle 700 with a footwell 702 covered by a load floor 704. The vehicle 700 is shown only in relevant part and many components have been omitted for clarity. While the first-row seats are not shown, second-row seats 706 are shown to be positioned immediately forward of the footwell 702, each of the second-row seats 706 having a respective seat recliner. The footwell 702 may in turn be located immediately forward of a motor bay for a rear motor, and the rear wheels, of the vehicle 700.

The load floor 704 can include two or more panels. Here the load floor 704 includes a load floor 708 positioned on the right side of the footwell 702, and a load floor 710 positioned on the left side of the footwell 702. The load floor 710 corresponds to the load floor 500 of FIG. 5, and the load floor 708 is a mirror image of the load floor 500 of FIG. 5. The load floors 708 and 710 can be separate from each other so that each of them can be either used or stored independently of the other. For example, the load floor 708 can be placed in the footwell 702 (e.g., as shown) while the load floor 710 is not in the footwell 702 (e.g., because a third-row seat on the left side of the vehicle 700 is currently deployed) and is stored elsewhere, or vice versa.

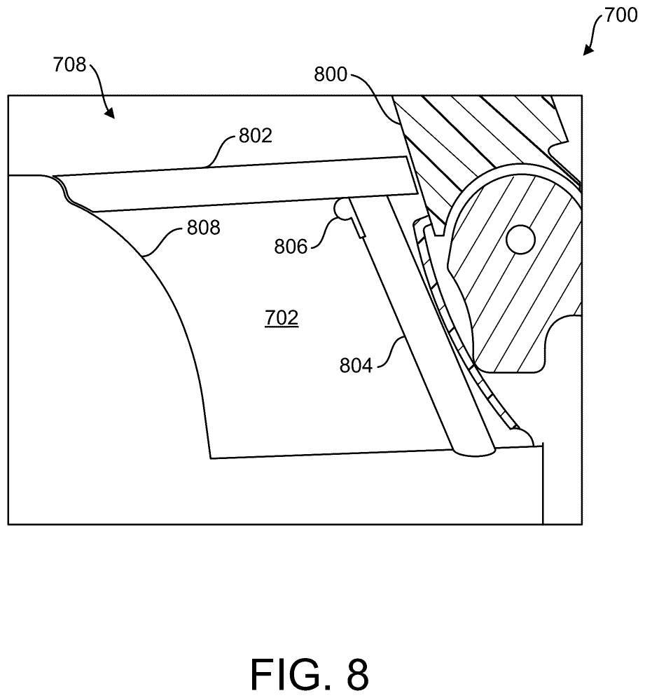

FIG. 8 shows an example section view of the vehicle 700 of FIG. 7 with a seat recliner 800 of the rightmost seat of the second-row seats 706 being in an upright position. The load floor 708 is here visible, having a load floor panel 802 and a leg panel 804 hinged to each other by a locking hinge 806. A front end of the load floor panel 802 (e.g., corresponding to the front end 504 of FIG. 5) here abuts the seat recliner 800. A rear end of the load floor panel 802 (e.g., corresponding to the rear end 506 of FIG. 5) here abuts trim 808 that covers a vehicle structure. For example, the vehicle structure can include a shape to be engaged with by the chamfer 508 of FIG. 5. The load floor 708 is here in an open locked position and has an end of the leg panel 804 resting on a floor of the footwell 702. As such, a load can be placed on the load floor panel 802 and the locking hinge 806 presents the load floor 708 from seesawing in a forward-backward direction.

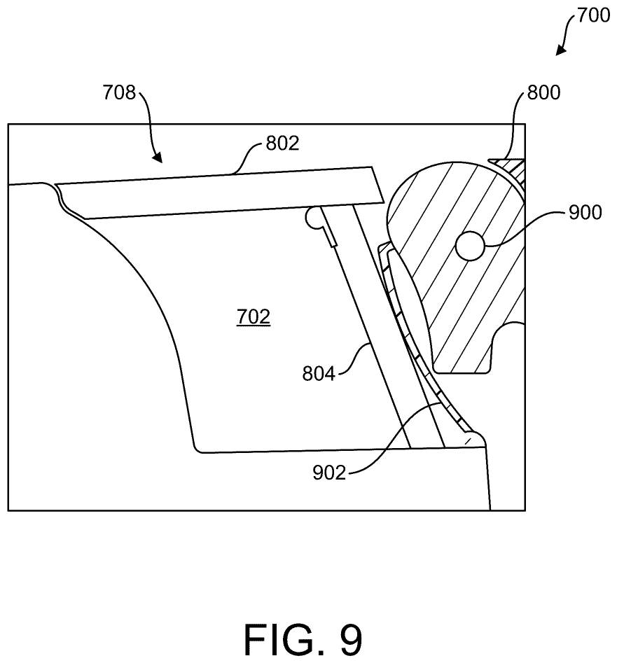

FIG. 9 shows an example section view of the vehicle 700 of FIG. 7 with the seat recliner 800 in a folded position. That is, the seat recliner 800 has here been rotated (clockwise, in the present illustration) about a pivot 900 from a comfort position into the folded position. For example, the folded position of the seat recliner 800 can make more space available for cargo in the vehicle 700. The leg panel 804 remains resting on the floor of the footwell 702 and here abuts a panel 902 mounted to the pivot 900 and the leg panel 804 is thereby prevented from moving forward. As such, the load floor panel 802 remains supported by the leg panel 804 and the load floor 708 in this open locked position is prevented from seesawing in the footwell 702.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one”.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A locking hinge comprising:
a first flange defining a rotation axis of the locking hinge, the first flange including a first knuckle and a first leaf, the first knuckle having a first end and a second end opposite the first end, the first knuckle having a first bore, the first knuckle having a slot at the second end, wherein a length of the first knuckle along the rotation axis is greater than a length of the first leaf along the rotation axis;
a hinge pin having a first end and a second end opposite the first end, the hinge pin having a shoulder at the first end, the hinge pin extending through the first bore of the first flange, the hinge pin having a key that extends perpendicularly to the rotation axis at the second end;
a second flange including a second knuckle and a second leaf, the second knuckle having a first end and a second end opposite the first end, the second knuckle having a second bore through which the first knuckle and the hinge pin extend, the second knuckle having a first slot at the second end; and
a biasing member positioned between the shoulder of the hinge pin and the first end of the first knuckle to provide a bias on the hinge pin toward a first position where the key extends through the slot of the first knuckle and through the first slot of the second knuckle so that the second flange is locked from rotating relative to the first flange, wherein translation of the hinge pin along the rotation axis against the bias of the biasing member places the hinge pin in a second position where the key extends through the slot of the first knuckle and does not extend through the first slot of the second knuckle so that the second flange is free to rotate relative to the first flange.

2. The locking hinge of claim 1, wherein the key of the hinge pin comprises two keys extending in opposite directions from the key, wherein the slot of the first knuckle comprises two slots formed opposite each other on the first knuckle, and wherein the first slot of the second knuckle comprises two first slots formed opposite each other on the second knuckle.

3. The locking hinge of claim 1, further comprising a cap attached to the first end of the first knuckle, the cap covering the first end of the first knuckle, the shoulder of the hinge pin, and the biasing member.

4. The locking hinge of claim 3, wherein the shoulder is formed by a sleeve attached to the first end of the hinge pin.

5. The locking hinge of claim 3, further comprising an opening in the cap for actuating the hinge pin to translate along the rotation axis.

6. The locking hinge of claim 5, further comprising a button attached to the first end of the hinge pin, the button extending out of the cap through the opening.

7. The locking hinge of claim 1, wherein an opening of the first slot is wider than a remainder of the first slot.

8. The locking hinge of claim 7, wherein the opening of the first slot has a rounded portion.

9. The locking hinge of claim 1, wherein in the first position of the hinge pin the first flange extends in substantially a same direction as the second flange.

10. The locking hinge of claim 1, wherein in the first position of the hinge pin the first flange forms a nonzero angle with the second flange.

11. The locking hinge of claim 1, wherein the second knuckle has also a second slot at the second end, and wherein the hinge pin has also a third position where the key extends through the slot of the first knuckle and through the second slot of the second knuckle so that the second flange is locked from rotating relative to the first flange and forms a different angle with the first flange than in the first position.

12. The locking hinge of claim 11, wherein an opening of the second slot is wider than a remainder of the second slot.

13. The locking hinge of claim 12, wherein the opening of the second slot has a rounded portion.

14. The locking hinge of claim 1, further comprising a rib on the first leaf of the first flange.

15. The locking hinge of claim 1, further comprising a rib on the second leaf of the second flange.

16. A load floor for a footwell of a vehicle, the load floor comprising:
a load floor panel configured to fit across the footwell of the vehicle;
a leg panel; and
a first locking hinge attached to the load floor panel and the leg panel, the first locking hinge comprising:
a first flange defining a rotation axis of the first locking hinge, the first flange including a first knuckle and a first leaf, the first knuckle having a first end and a second end opposite the first end, the first knuckle having a first bore, the first knuckle having a first slot at the second end, wherein a length of the first knuckle along the rotation axis is greater than a length of the first leaf along the rotation axis;
a hinge pin having a first end and a second end opposite the first end, the hinge pin having a shoulder at the first end, the hinge pin extending through the first bore of the first flange, the hinge pin having a key that extends perpendicularly to the rotation axis at the second end;
a second flange including a second knuckle and a second leaf, the second knuckle having a first end and a second end opposite the first end, the second knuckle having a second bore through which the first knuckle and the hinge pin extend, the second knuckle having a second slot at the second end; and
a biasing member positioned between the shoulder of the hinge pin and the first end of the first knuckle to provide a bias on the hinge pin toward a first position where the key extends through the first slot of the first knuckle and through the second slot of the second knuckle so that the second flange is locked from rotating relative to the first flange, wherein the hinge pin being in the first position corresponds to the leg panel extending between the load floor panel and a bottom of the footwell of the vehicle and supporting the load floor panel, wherein translation of the hinge pin along the rotation axis against the bias of the biasing member places the hinge pin in a second position where the key extends through the first slot of the first knuckle and does not extend through the second slot of the second knuckle so that the second flange is free to rotate relative to the first flange.

17. The load floor of claim 16, further comprising a second locking hinge attached to the load floor panel and the leg panel.

18. The load floor of claim 17, wherein the first locking hinge has a first button for unlocking the first locking hinge, the first locking hinge positioned so that the first button is located at a first side edge of the load floor, and wherein the second locking hinge has a second button for unlocking the second locking hinge, the second locking hinge positioned so that the second button is located at a second side edge of the load floor opposite to the first side edge.

19. The load floor of claim 16, wherein the hinge pin has also a third position where the key extends through the first slot of the first knuckle and through a third slot of the second knuckle so that the second flange is locked from rotating relative to the first flange and forms a different angle with first flange than in the first position.

20. The load floor of claim 19, wherein in the third position of the hinge pin the load floor panel extends in substantially a same direction as the leg panel.
